(19) United States
(12) Patent Application Publication
(10) Pub. No.: US 2024/0025764 A1
(43) Pub. Date: Jan. 25, 2024

(54) IRIDIUM-CONTAINING OXIDE, METHOD FOR PRODUCING SAME AND CATALYST CONTAINING IRIDIUM-CONTAINING OXIDE

(71) Applicant: FURUYA METAL CO., LTD., Tokyo (JP)

(72) Inventors: Yasuyuki Ikeda, Tokyo (JP); Kenji Terada, Tokyo (JP); Hiroaki Suzuki, Tokyo (JP); Junichi Watanabe, Tokyo (JP); Takashi Ito, Tokyo (JP)

(73) Assignee: FURUYA METAL CO., LTD., Tokyo (JP)

(21) Appl. No.: 18/255,657

(22) PCT Filed: Dec. 14, 2021
(86) PCT No.: PCT/JP2021/045955

§ 371 Date: Jun. 2, 2023

(30) Foreign Application Priority Data
Dec. 24, 2020 (JP) 2020-215039

(51) Int. Cl. C01G 55/00; B01J 23/46; C25B 11/077

(52) U.S. Cl. CPC C01G 55/004; B01J 23/468; C25B 11/0775; C01P 2002/30; C01P 2006/12; C25B 1/04

(57) ABSTRACT

An iridium-containing oxide having a total pore volume of 0.20 cm³/g or more, calculated by a BJH method from nitrogen adsorption/desorption isotherm measurement, and a pore distribution having an average pore diameter of 7.0 nm or more.

### TECHNICAL FIELD

The present disclosure relates to an iridium-containing oxide to have high activity and a long life upon usage thereof as an electrode catalyst in the field of water electrolysis and the like, a method for producing the same, and a catalyst containing the iridium-containing oxide.

### BACKGROUND ART

In general, an iridium oxide has characteristics of good electrical conductivity and high catalytic ability for the oxidation reaction of water. Since the iridium oxide has very high corrosion resistance even under strongly acidic and strongly basic conditions, the iridium oxide has been used for various electrode materials, and has been conventionally used as a shape stabilizing electrode material in the field of soda electrolysis and the field of electroplating. In particular, recently, by making the iridium oxide into nanoparticles, the nanoparticles have attracted attention as a gas diffusion electrode catalyst for an oxygen evolution reaction (OER), an oxygen reduction reaction (ORR), a chlorine evolution reaction (CER) and the like in applications such as cation exchange membrane water electrolysis, cation exchange membrane fuel cells, seawater electrolysis, and photocatalytic water decomposition, or have attracted in an electrode material application for a supercapacitor.

In particular, a cation exchange membrane water electrolysis anode catalyst and a cation exchange membrane fuel cell reverse potential durability catalyst are expected to be widely put to practical use as a water electrolysis catalyst.

In recent years, the cation exchange membrane water electrolysis has attracted attention for the storage of renewable energy toward the coming hydrogen energy society, and the development of high-efficient megawatt-level large size cation exchange membrane water electrolyzer has been accelerated.

The development of the cation exchange membrane fuel cell has been accelerated as a clean transportation means in the coming hydrogen energy society.

A cation exchange membrane water electrolysis cell is configured by joining a plurality of constituent units in series with a separator disposed between the adjacent constituent units.

Each of the constituent units is a membrane electrode assembly (hereinafter abbreviated as MEA) configured by sandwiching a catalyst coated membrane (hereinafter abbreviated as CCM), configured by sandwiching a cation exchange polymer electrolyte membrane such as Nafion (registered trademark) between an anode catalyst layer and a cathode catalyst layer, between gas diffusion layers. When water is supplied to the anode catalyst layer, a reaction of (Chemical Formula 1) occurs in the anode catalyst layer, and a reaction of (Chemical Formula 2) occurs in the cathode catalyst layer. Oxygen (O₂) is generated on an anode side and hydrogen (H₂) is generated on a cathode side.

H₂O(liq.)→1/2O₂(g)+2H⁺+2e⁻ (Chemical Formula 1)

2H⁺+2e^{-→H}₂(g) (Chemical Formula 2)

The rate limiting step of the overall reaction is the oxidation of water on the anode side, that is, an oxygen evolution reaction, and the oxygen evolution reaction (OER) mass activity of an anode catalyst is an important factor that affects the efficiency of the system.

Regarding an anode for oxygen evolution used for industrial electrolysis, a technique is disclosed, which can reduce an oxygen evolution overvoltage and produce a highly active and highly durable electrode by setting the crystallite size of an iridium oxide to 9.7 nm or less and increasing the degree of crystallinity thereof (see, for example, Patent Literature 1).

Meanwhile, in the cation exchange membrane fuel cell, a reaction of (Chemical Formula 3) occurs at a cathode and a reaction of (Chemical Formula 4) occurs at an anode. As a whole, an electromotive force is generated by (Chemical Formula 5). The cation exchange membrane fuel cell is used by being connected to an external circuit.

1/2O₂(g)+2H⁺+2e⁻→H₂O (Chemical Formula 2)

H₂(g)→2H⁺+2e⁻ (Chemical Formula 4)

1/2O₂(g)+H₂(g)→H₂O (Chemical Formula 5)

However, when the supply of hydrogen to the anode side is insufficient in the starting/stopping of the fuel cell, a fuel shortage state occurs, and a current is caused forcibly to flow from another cell connected in series to the cell in the fuel shortage state, whereby the following reaction of (Chemical Formula 6) occurs. This causes a platinum-supported carbon-based electrode catalyst to be oxidized and corroded, whereby the fuel cell cannot be used.

C+2H₂O→CO₂+4H⁺+4e⁻ (Chemical Formula 6)

2H₂O→O₂+4H⁺+4e⁻ (Chemical Formula 7)

In order to control the oxidative corrosion of a carbon carrier by water under such a reverse potential condition, the addition of an iridium oxide-based nanoparticle catalyst has been studied as an electrolysis catalyst for electrolyzing water under the reaction of (Chemical Formula 7) (see, for example, Patent Literature 2).

A technique for producing fine particles using high-temperature and high-pressure water as a method for producing fine particles is disclosed although an iridium oxide is not mentioned. In the technique, water is converted into high-temperature and high-pressure water in a supercritical state or a subcritical state via a pressurizing means and a heating means. The high-temperature and high-pressure water and a fluid raw material are merged and mixed in a mixing unit, and then guided to a reactor. The fluid raw material is cooled to a temperature lower than the critical temperature of water before being merged with the high-temperature and high-pressure water (see, for example, Patent Literature 3).

As a method for producing an iridium oxide as a catalyst for oxygen evolution reaction by cation exchange membrane water electrolysis, a sol-gel method, an aqueous solution hydrolysis method, Adam's melting method and the like are disclosed as reviews (see, for example, Non Patent Literature 1).

A method for producing an iridium oxide is disclosed, for use as a water electrolysis oxygen evolution anode catalyst, in which an iridium salt is hydrolyzed using ammonia water, a nitrate is added to an intermediate thereof, and the mixture is heated, dried, and melted. (see, for example, Patent Literature 4).

A method for testing the reverse potential durability of an anode of a cation exchange membrane fuel cell is disclosed, and the comparison of the durabilities with and without addition of a water electrolysis catalyst component to the anode is disclosed (see, for example, Non Patent Literature 2).

### CITATION LIST

### Patent Literature

Patent Literature 1: JP 2014-526608 A
Patent Literature 2: JP 2003-508877 A
Patent Literature 3: JP 2005-21724 A
Patent Literature 4: JP 2020-132465 A

### Non Patent Literature

Non Patent Literature 1: PEM Electrolysis for Hydrogen Production-Principales and Applications,CRC Press(2016),53-55
Non Patent Literature 2: Tsutomu IOROI, Kazuaki YASUDA, Proceedings of the 59th Battery Symposium in Japan (November 2018, Osaka), Lecture No. 1H23

### SUMMARY OF INVENTION

### Technical Problem

Iridium is an expensive noble metal because an annual production amount of thereof is only 9 t in comparison with that of platinum group metals of 454 t. However, iridium needs to be used in a large amount as an electrode catalyst, and it is required to reduce the used amount of iridium and to reduce the frequency of electrode replacement. Therefore, a highly efficient and highly durable electrode catalyst has been required.

In order to develop a highly efficient iridium oxide, the present inventors have searched for a method for producing an iridium oxide having a large specific surface area for the purpose of high activation. However, the present inventors have found that increasing the specific surface area makes the catalytic activity improved but makes the durability reduced. Therefore, it is important to increase the catalytic activity while maintaining the durability.

The iridium oxide has been conventionally used as an anode catalyst for oxygen evolution in industrial electrolysis, but in Patent Literature 1, the crystallite size of the iridium oxide having a high degree of crystallinity is as large as about 6 nm to 10 nm, so that the anode catalyst has a low specific surface area and has insufficient activity although the anode catalyst is durable.

Patent Literature 2 discloses the remarkable effects of, in particular, a ruthenium oxide and a mixed oxide of a ruthenium oxide and an iridium oxide as a water electrolysis catalyst component, but discloses that the effect of only the iridium oxide includes durability but includes insufficient activity.

In Patent Literature 3 that discloses a method for producing fine particles made of a metal and a metal oxide and the like, heating and cooling are repeatedly performed, whereby the crystallite size is repeatedly increased or decreased. This may cause variation in the crystallite size, which has a high possibility that the durability and the catalytic activity vary depending on the particles.

Patent Literature 4 discloses the iridium oxide having a specific surface area of 150 m²/g or more and an average pore diameter of 2.3 nm or more and 4.0 nm or less, which has high activity but has insufficient durability.

Non Patent Literature 1 reports various conventionally known methods for producing an iridium oxide as an oxygen evolution reaction catalyst for cation exchange membrane water electrolysis, but does not describe a hydrothermal synthesis method using supercritical water or subcritical water in a reaction field.

Non Patent Literature 2 describes iridium black as a reverse potential durability water electrolysis catalyst component, but does not teach the catalytic action of the iridium oxide.

Therefore, an object of the present disclosure is to provide an iridium-containing oxide, capable of having both high activity and high durability upon usage thereof as an electrode catalyst, as a result of controlling the pore structure of an iridium oxide, and a method for producing the same. Another object of the present invention is to provide a highly active and highly durable water electrolysis catalyst containing such an iridium-containing oxide for a cation exchange membrane water electrolysis anode and a reverse potential durability electrode of a cation exchange membrane fuel cell.

### Solution to Problem

As a result of intensive studies to solve the above problems, the present inventors have found that the problems are solved by an iridium-containing oxide having an unconventional specific pore structure and a method for producing the same, and have completed the present invention. That is, the iridium-containing oxide has a total pore volume of 0.20 cm³/g or more, calculated by a BJH method from nitrogen adsorption/desorption isotherm measurement, and a pore distribution having an average pore diameter of 7.0 nm or more.

It is preferable that the iridium-containing oxide according to the present invention has hysteresis in a region where a relative pressure (P/P₀) of a nitrogen adsorption/desorption isotherm is 0.7 to 0.95. Furthermore, the iridium-containing oxide preferably has a BET specific surface area of 100 m²/g or more. A catalyst having higher activity and higher durability can be obtained.

The iridium-containing oxide according to the present invention is in the form of a powder or dispersed particles, and the powder or the dispersed particles has a large total pore volume of 0.20 cm³/g or more, calculated by a BJH method from nitrogen adsorption/desorption isotherm measurement, and a large average pore diameter of 7.0 nm. It is preferable that the iridium-containing oxide has hysteresis in a region where a relative pressure (P/P₀) of an adsorption/desorption isotherm is 0.7 to 0.95, and it is preferable that the iridium-containing oxide has a large BET specific surface area of 100 m²/g.

The iridium-containing oxide according to the present invention includes an embodiment in which the iridium-containing oxide is an iridium oxide or a composite oxide of iridium and an element whose oxide has a rutile type crystal structure, and the iridium oxide or the composite oxide has a rutile type crystal structure.

A method for producing an iridium-containing oxide according to the present invention is a method for producing the iridium-containing oxide according to the present invention and includes: a step A of (1) dispersing iridium nanoparticles or iridium hydroxide particles as a raw material in a medium to obtain a dispersion liquid or (2) dissolving an iridium compound as a raw material in a solvent to obtain a solution; a step B of converting water into high-temperature and high-pressure water under high-temperature and high-pressure conditions of a heating temperature of 100° C. or higher and an applied pressure of 0.1 MPa or more; and a step C of mixing the dispersion liquid or the solution obtained in the step A with the high-temperature and high-pressure water obtained in the step B.

In the method for producing the iridium-containing oxide according to the present invention, it is preferable that in the step A, the solvent has a temperature of 15 to 30° C., and the iridium compound as the raw material is dissolved in the solvent. The iridium-containing oxide having a large total pore volume can be produced, and the iridium-containing oxide having high activity and high durability can be obtained.

In the method for producing the iridium-containing oxide according to the present invention, it is preferable that the step B includes any one of the steps of: (1) adding an oxidant that releases oxygen atoms to the water and then converting the water into the high-temperature and high-pressure water; (2) converting the water into the high-temperature and high-pressure water and then adding an oxidant that releases oxygen atoms to the high-temperature and high-pressure water; or (3) adding an oxidant that releases oxygen atoms to the water, then converting the water into the high-temperature and high-pressure water, and further adding an oxidant that releases oxygen atoms to the high-temperature and high-pressure water. The oxidation reaction can be efficiently performed in the step C.

A cation exchange membrane water electrolysis anode catalyst according to the present invention includes the iridium-containing oxide according to the present invention. Since the cation exchange membrane water electrolysis anode catalyst is synthesized under a hydrothermal condition, the cation exchange membrane water electrolysis anode catalyst has a unique pore structure. In particular, the cation exchange membrane water electrolysis anode catalyst has a large average pore diameter of 7.0 nm or more, whereby in preparing an electrode of a cation exchange membrane water electrolysis anode, the affinity with ionomer molecules as a binder of a cation exchange resin having an average molecular diameter of about 10 nm, for example, Nafion (registered trademark), is increased, and the electrode having high activity and excellent durability can be provided.

A reverse potential durability catalyst for cation exchange membrane fuel cell according to the present invention includes an electrode catalyst layer containing the iridium-containing oxide according to the present invention. Since the reverse potential durability catalyst for cation exchange membrane fuel cell is synthesized under a hydrothermal condition, the reverse potential durability catalyst for cation exchange membrane fuel cell has a unique pore structure.

In particular, the reverse potential durability catalyst for cation exchange membrane fuel cell has a large average pore diameter of 7.0 nm or more, whereby in preparing an electrode of a cation exchange membrane fuel cell, the affinity with ionomer molecules as a binder of a cation exchange resin having an average molecular diameter of about 10 nm, for example, Nafion (registered trademark), is increased, and the electrode having high activity and excellent durability can be provided.

### Advantageous Effects of Invention

An iridium-containing oxide according to the present disclosure has a unique pore structure having a large total pore volume of 0.20 cm³/g or more, calculated by a BJH method from nitrogen adsorption/desorption isotherm measurement, and a large average pore diameter of 7.0 nm or more. It is more preferable that the iridium-containing oxide is provided, which has hysteresis in a region where a relative pressure (P/P₀) of a nitrogen adsorption/desorption isotherm is 0.7 to 0.95, and has a large BET specific surface area of 100 m²/g or more. Upon usage of the iridium-containing oxide having such a pore distribution and physical properties as a cation exchange membrane water electrolysis anode catalyst or a reverse potential durability catalyst for cation exchange membrane fuel cell, an unconventional electrode having high activity and excellent durability can be obtained. A method for producing an iridium-containing oxide according to the present disclosure can produce an iridium-containing oxide having a specific pore structure having a large pore volume and a large average pore diameter, and can secure an iridium-containing oxide to have high activity and high durability upon usage thereof as an electrode catalyst.

According to the present disclosure, when the iridium-containing oxide is used as the cation exchange membrane water electrolysis anode catalyst, high activity and high durability of the iridium-containing oxide can reduce the used amount of iridium per the unit electrode area of an electrode to about 1/2 to 1/5 of a conventional used amount. By adding the iridium-containing oxide to a platinum-supported carbon-based electrode catalyst of a cation exchange membrane fuel cell, the reverse potential durability is significantly improved. Since the influence of fuel shortage is more serious on the anode side of the cation exchange membrane fuel cell, a water electrolysis catalyst is mixed with the hydrogen oxidation catalyst component of an anode. However, since the influence of a reverse potential may also occur on a cathode side, a cathode catalyst layer can be mixed with an oxygen reduction catalyst component.

### BRIEF DESCRIPTION OF DRAWINGS

FIG. 1 shows an example of an apparatus for producing an iridium-containing oxide according to the present embodiment.

FIG. 2 shows the nitrogen adsorption/desorption isotherm of an iridium-containing oxide in Example 1.

FIG. 3 shows the nitrogen adsorption/desorption isotherm of an iridium-containing oxide in Example 2.

FIG. 4 shows the nitrogen adsorption/desorption isotherm of an iridium-containing oxide in Example 3.

FIG. 5 shows the nitrogen adsorption/desorption isotherm of an iridium-containing oxide in Comparative Example 1.

FIG. 6 shows the nitrogen adsorption/desorption isotherm of an iridium-containing oxide in Comparative Example 2.

FIG. 7 is a graph showing the comparison of OER mass activities of catalysts of Examples and Comparative Examples.

FIG. 8 is a graph showing the comparison of water electrolysis single cell accelerated degradation tests using catalysts of Examples and Comparative Examples as anodes.

FIG. 9 is a graph showing the comparison of fuel cell single cell reverse potential durability tests using electrodes in which catalysts of Examples and Comparative Examples are added to anodes.

FIG. 10 shows the nitrogen adsorption/desorption isotherm of an iridium-containing oxide in Example 7.

### DESCRIPTION OF EMBODIMENTS

Next, the present invention will be described in detail with reference to embodiments, but the present invention is not construed as being limited to these descriptions. The embodiments may be variously modified as long as the effect of the present invention is exhibited.

An iridium-containing oxide according to the present embodiment has a total pore volume of 0.20 cm³/g or more, calculated by a BJH method from nitrogen adsorption/desorption isotherm measurement, and a pore distribution having an average pore diameter of 7.0 nm or more. It is preferable that the iridium-containing oxide according to the present invention has hysteresis in a region where a relative pressure (P/P₀) of a nitrogen adsorption/desorption isotherm is 0.7 to 0.95, and it is more preferable that the iridium-containing oxide has a BET specific surface area of 100 m²/g or more. A catalyst having higher activity and higher durability can be obtained. The relative pressure (P/P₀) is defined as a ratio of a pressure P under which nitrogen molecules are adsorbed on a solid surface to the saturated vapor pressure P₀ of nitrogen.

The iridium-containing oxide according to the present embodiment has a relatively flat relative pressure (P/P₀) of about 0.05 to 0.7 and a steep rising relative pressure of about 0.7 to 0.95 in the nitrogen adsorption/desorption isotherm. Moreover, it is preferable that the iridium-containing oxide has so-called hysteresis in which a deviation occurs in isotherms in the processes of adsorption and desorption. The hysteresis is considered to be caused by the phenomenon of capillary condensation of liquid nitrogen in the desorption process, and is considered to be a phenomenon specific to a mesopore structure. The iridium-containing oxide according to the present embodiment hardly has micropores having a pore diameter of less than 2.0 nm or mesopores having a relatively small pore diameter of 2.0 nm or more and less than 5.0 nm, and most of the pores have a pore distribution having mesopores having a relatively large pore diameter of 5.0 nm or more and 50 nm or less. As a result, the iridium-containing oxide has an average pore diameter of 7.0 nm or more and a large total pore volume of 0.20 cm³/g or more, calculated by the BJH method.

The iridium-containing oxide according to the present embodiment contains, in addition to an iridium oxide (IrO₂), a composite oxide of Ir and an element having a rutile type crystal structure, such as TiO₂, NbO₂, TaO₂, SnO₂, or RuO₂. The composite oxide has an average pore diameter of 7.0 nm or more and a large total pore volume of 0.20 cm³/g or more. The iridium oxide or the composite oxide of iridium and an element whose oxide has a rutile type crystal structure preferably has a rutile type crystal structure. Impurities other than iridium and the additional element may be contained as long as the properties of the iridium-containing oxide according to the present embodiment are not impaired.

The iridium-containing oxide according to the present embodiment preferably has a BET specific surface area of 100 m²/g or more. Even when the specific surface area is large, the average pore diameter of 7.0 nm or more and the total pore volume of 0.20 cm³/g or more do not cause reduction of the durability but improve the activity.

It is considered that the iridium-containing oxide according to the present embodiment is in the form of a monodisperse nanoparticle powder or aggregate particles thereof, and has a specific pore structure constituted by the surfaces of the particles and an interface of the aggregate.

The ratio of iridium to oxygen in the iridium-containing oxide according to the present embodiment is preferably 30:70 to 40:60 in atom %, and more preferably 32:68 to 34:66. When the iridium-containing oxide according to the present embodiment is the composite oxide of Ir and an element having a rutile type crystal structure, such as TiO₂, NbO₂, TaO₂, SnO₂, or RuO₂, the ratio of the total amount of iridium and the element having a rutile type crystal structure to oxygen is preferably 30:70 to 40:60 in atom %, and more preferably 32:68 to 34:66.

A method for producing an iridium-containing oxide according to the present embodiment is a method for producing the iridium-containing oxide according to the present embodiment and includes: a step A of (1) dispersing iridium nanoparticles or iridium hydroxide particles as a raw material in a medium to obtain a dispersion liquid or (2) dissolving an iridium compound as a raw material in a solvent to obtain a solution; a step B of converting water into high-temperature and high-pressure water under high-temperature and high-pressure conditions of a heating temperature of 100° C. or higher and an applied pressure of 0.1 MPa or more; and a step C of mixing the dispersion liquid or the solution obtained in the step A with the high-temperature and high-pressure water obtained in the step B.

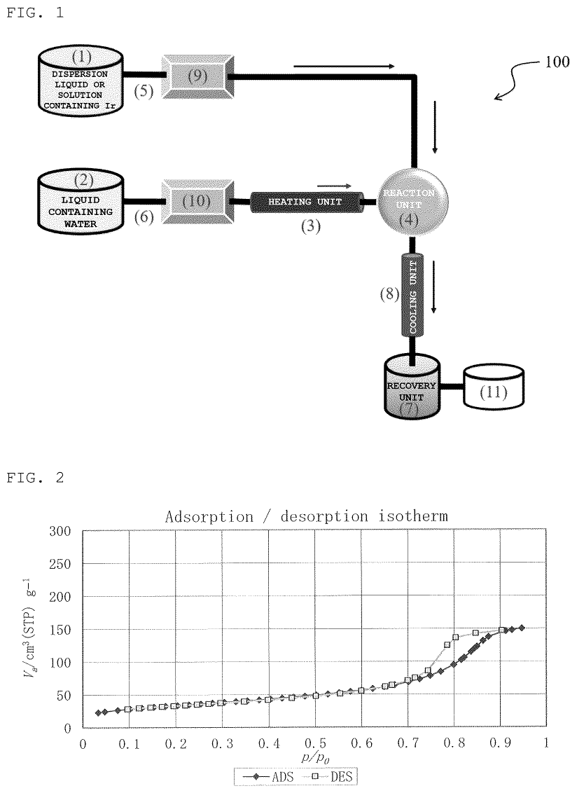

Here, an example of an apparatus for producing an iridium-containing oxide will be described with reference to FIG. 1. An apparatus 100 for producing an iridium-containing oxide according to the present embodiment includes at least a first source (1) of a dispersion liquid or a solution containing iridium, a second source (2) of a liquid containing water, a heating unit (3) for heating the liquid containing water, a reaction unit (4) for joining the dispersion liquid or solution containing iridium and the liquid containing water, a liquid feeding route (5) connecting the first source (1) and the reaction unit (4), a liquid feeding route (6) connecting the second source (2) and the reaction unit (4), a recovery unit (7) connected to the reaction unit (4) via a pipe and recovering a produced reaction product, and a cooling unit (8) between the reaction unit (4) and the recovery unit (7). A pressure adjustment mechanism (11) is connected to the recovery unit (7). The pressure adjustment mechanism (11) may be connected between the cooling unit (8) and the recovery unit (7). According to the apparatus for producing an iridium-containing oxide according to the present embodiment, particles made of the iridium-containing oxide can be stably produced.

In the apparatus for producing an iridium-containing oxide according to the present embodiment, iridium in the dispersion liquid or solution can be oxidized to produce the iridium-containing oxide by mixing the dispersion liquid or solution containing iridium with high-temperature and high-pressure water in the reaction unit (4). The high-temperature and high-pressure water is obtained by the heating unit (3). The high temperature and high pressure water includes water in a high temperature and high pressure state, and a liquid obtained by bringing water containing an oxidant such as oxygen, hydrogen peroxide, or ozone into a high temperature and high pressure state.

The liquid feeding route (5) connecting the first source (1) and the reaction unit (4) includes a pipe. As a means for adjusting the flow rate of a liquid flowing in the pipe, there is a method for disposing the first source (1) at a position higher than that of the reaction unit (4) to utilize a height difference therebetween. In this state, the dispersion liquid or solution containing iridium can be carried from the first source (1) to the reaction unit (4) only by the pipe. Thereat, a valve for reducing the flow rate, such as a needle valve or a stop valve, may be disposed in the liquid feeding route (5).

The liquid feeding route (6) connecting the second source (2) and the reaction unit (4) includes a pipe. As a means for adjusting the flow rate of a liquid flowing in the pipe, there is a method for disposing the second source (2) at a position higher than that of the reaction unit (4) to utilize a height difference therebetween. In this state, the liquid containing water can be carried from the second source (2) to the reaction unit (4) only by the pipe. Thereat, similarly to the liquid feeding route (5), a valve for reducing the flow rate, such as a needle valve or a stop valve, may be disposed in the liquid feeding route (6).

The apparatus for producing an iridium-containing oxide according to the present embodiment may have mechanisms (9) and (10) for transferring a liquid flowing through either one or both of the liquid feeding route (5) and the liquid feeding route (6) in one direction. In the apparatus 100 for producing an iridium-containing oxide shown in FIG. 1, an embodiment having the mechanisms (9) and (10) provided in both the liquid feeding route (5) and the liquid feeding route (6) is illustrated. In this embodiment, the flow rates and the flow speeds of the dispersion liquid or solution containing iridium and the liquid containing water can be stably defined in the liquid feeding route (5) and the liquid feeding route (6), so that the iridium-containing oxide can be stably produced.

Each of the mechanisms (9) and (10) is a means for adjusting the flow rate of the liquid flowing in the pipe, and is, for example, a plunger, a cylinder, or a regulator.

A dispersion medium for the iridium nanoparticles or iridium hydroxide particles can be freely selected as long as these can be dispersed, and examples thereof include water and an organic solvent. The solvent that dissolves the iridium compound can be freely selected as long as the solvent is a liquid at normal temperature, and examples thereof include water and an organic solvent. In the present embodiment, the normal temperature is 15° C. to 30° C., and preferably 20° C. to 25° C.

[(1) of Step A]

The particle size of the iridium nanoparticles as a raw material is preferably 3.0 nm or less, and more preferably 2.5 nm or less. When the particle size of the iridium nanoparticles is larger than 3.0 nm, iridium oxide particles having a desired crystallite size cannot be obtained upon reaction of iridium with oxygen, and oxidation may be insufficient. The particle size of the iridium hydroxide particles is preferably 3.0 nm or less, and more preferably 2.5 nm or less.

When the particle size of the iridium hydroxide particles is larger than 3.0 nm, iridium oxide particles having a desired crystallite size cannot be obtained upon reaction of iridium hydroxide with oxygen, and oxidation may be insufficient upon reaction of iridium hydroxide with oxygen.

By adding the iridium nanoparticles or the iridium hydroxide particles satisfying the above conditions to the medium, a dispersion liquid in which the iridium nanoparticles or the iridium hydroxide particles are dispersed in the medium can be obtained. Examples of the medium include water and ethanol.

[(2) of Step A]

The iridium compound as a raw material may be any of an iridium-containing metal salt, typically an iridium nitric acid compound, an iridium sulfuric acid compound, an iridium acetic acid compound, or an iridium chloride, and a metal complex such as iridium acetylacetonate or iridium carbonyl, and is preferably an iridium nitric acid compound, an iridium sulfuric acid compound, or an iridium acetic acid compound. By adding the iridium compound to a solvent, a solution in which the iridium compound is dissolved in the solvent can be obtained. The solvent is, for example, water when dissolving the iridium-containing metal salt; or ethanol, ethyl acetate or the like when dissolving the iridium-containing metal complex. In (2) of the step A, the solvent has room temperature, for example, a temperature of 15° C. to 30° C., and it is preferable to dissolve the iridium compound as a raw material in the solvent.

[Step B]

Separately from the step A, water is converted into high-temperature and high-pressure water under conditions of a heating temperature of 100° C. or higher and an applied pressure of 0.1 MPa or more. The condition of the heating temperature is 100° C. or higher, more preferably 150° C. or higher, and most preferably 374° C. or higher. The condition of the heating temperature is, for example, 400° C. The condition of the applied pressure is 0.1 MPa or more, more preferably 0.5 MPa or more, and most preferably 22.1 MPa or more. The condition of the applied pressure is, for example, 30 MPa. Water for obtaining the high temperature and high pressure water is preferably pure water, but may be a solution in which an oxidant such as oxygen, hydrogen peroxide, or ozone is dissolved in water.

In order to efficiently perform the oxidation reaction in the step C, it is preferable that the step B includes any one of the steps of: (1) adding an oxidant that releases oxygen atoms to the water and then converting the water into the high-temperature and high-pressure water; (2) converting the water into the high-temperature and high-pressure water and then adding an oxidant that releases oxygen atoms to the high-temperature and high-pressure water; or (3) adding an oxidant that releases oxygen atoms to the water, then converting the water into the high-temperature and high-pressure water, and further adding an oxidant that releases oxygen atoms to the high-temperature and high-pressure water. In the case of oxygen gas, it is preferable to bring water having a saturated oxygen concentration into a high-temperature and high-pressure state. Examples of the oxidant that releases oxygen atoms include oxygen, hydrogen peroxide, and ozone.

[Step C]

The dispersion liquid or solution obtained in the step A is mixed with the high-temperature and high-pressure water obtained in the step B. The conditions for mixing are not particularly limited, but when using a pipe having a small capacity, or the like, it is possible to obtain a dispersion liquid in which the iridium-containing oxide is dispersed in the high temperature and high pressure water by joining the pipe containing the dispersion liquid or solution obtained in the step A and the pipe containing the high temperature and high pressure water obtained in the step B. When using a container having a large capacity, or the like, the dispersion liquid or solution obtained in the step A and the high-temperature and high-pressure water obtained in the step B are put in a container and mixed by stirring or the like, so that a dispersion liquid in which the iridium-containing oxide is dispersed in the high-temperature and high-pressure water can be obtained. In FIG. 1, mixing is performed in the reaction unit (4).

The solution obtained in the step C is cooled, for example, in the cooling unit (8) shown in FIG. 1, and then recovered in the recovery unit (7). Then, the sample is separated or washed by filtration or centrifugation or the like, and dehydrated in a dryer, so that iridium-containing oxide nanoparticles can be obtained.

[Cation Exchange Membrane Water Electrolysis Anode Catalyst]

Next, a cation exchange membrane water electrolysis anode catalyst containing an iridium-containing oxide according to the present embodiment will be described. As a cation exchange membrane for water electrolysis cell, various cation exchange membranes such as perfluorosulfonic acid-based, sulfonated polyethylene ether ketone-based, and sulfonated polybenzimidazole-based cation exchange membranes are used. Above all, perfluorosulfonic acid-based Nafion (registered trademark, manufactured by Du Pont), Flemion (registered trademark, manufactured by AGC), Aciplex (registered trademark, manufactured by Asahi Kasei Corporation), Fumion (registered trademark, manufactured by Fumatech), Aquivion (registered trademark, manufactured by Solvay) and the like can be suitably used. As a cathode catalyst of a cation-exchange membrane water electrolysis cell, platinum black or a platinum-supported carbon black catalyst having high hydrogen evolution reaction activity is usually used. The iridium-containing oxide according to the present embodiment is stirred and mixed with the same cation exchange resin ionomer as the above cation exchange membrane component in a solvent to prepare an anode catalyst ink. The ratio between the iridium-containing oxide and the ionomer is not particularly limited, but a composition having a ratio of 1:0.2 to 1:0.05 is suitably used, and a composition having a ratio of 1:0.15 to 1:0.07 is more suitably used. The solvent is not particularly limited, but water or a mixture of water and a lower aliphatic alcohol such as ethanol, propanol, or butanol is suitably used. The cathode catalyst is also mixed with the ionomer to prepare a cathode catalyst ink. A method for preparing CCM by coating an anode catalyst layer and a cathode catalyst layer on the front and back surfaces of the cation exchange membrane from the anode catalyst ink and the cathode catalyst ink thus prepared is not particularly limited, and a known method such as a direct coating method by a bar coating method or a spray coating method or the like, or a method in which an anode catalyst layer and a cathode catalyst layer are separately coated on a Teflon (registered trademark) film in advance and then transferred by hot pressing or the like can be applied. The supported amount of the cation exchange membrane water electrolysis anode catalyst according to the present embodiment on the cation exchange membrane is not particularly limited, but is suitably 2.0 mg/cm² to 0.1 mg/cm², and more suitably 1.0 mg/cm² to 0.3 mg/cm². As described above, there is provided an anode catalyst capable of operating a water electrolysis cell at a higher current density of 1.0 A/cm² to 5.0 A/cm² and a lower electrolysis voltage (internal resistance free) of 1.5 V to 1.7 V with an amount of iridium significantly smaller than the used amount of iridium in a conventional cation exchange membrane water electrolysis cell, and capable of maintaining durability for tens of thousands of hours or more.

[Reverse Potential Durability Catalyst for Cation Exchange Membrane Fuel Cell]

Next, a reverse potential durability water electrolysis catalyst for cation exchange membrane fuel cell including an electrode catalyst layer containing an iridium-containing oxide according to the present embodiment will be described. As a cation exchange membrane of a cation exchange membrane fuel cell, various cation exchange membranes such as perfluorosulfonic acid-based, sulfonated polyethylene ether ketone-based, and sulfonated polybenzimidazole-based cation exchange membranes are used. Above all, perfluorosulfonic acid-based Nafion (registered trademark, manufactured by Du Pont), Flemion (registered trademark, manufactured by AGC), Aciplex (registered trademark, manufactured by Asahi Kasei Corporation), Fumion (registered trademark, manufactured by Fumatech), Aquivion (registered trademark, manufactured by Solvay) and the like can be suitably used. As the oxygen reduction catalyst component of the cathode and the hydrogen oxidation catalyst component of the anode of the cation exchange membrane fuel cell, conventionally known materials can be used. A typical oxygen reduction catalyst is graphitized carbon black on which Pt or a platinum alloy such as Pt—Co is supported, and a typical hydrogen oxidation catalyst is carbon black on which Pt is supported. The supported amount of the iridium-containing oxide water electrolysis catalyst added to the anode catalyst layer and the cathode catalyst layer for improving the reverse potential durability of the cation exchange membrane fuel cell is not particularly limited, but is suitably 2% by mass to 50% by mass, and more suitably 5% by mass to 20% by mass with respect to the oxygen reduction catalyst component or the hydrogen oxidation catalyst component.

The supported amount of the iridium-containing oxide in the anode catalyst layer in the present embodiment is preferably in the range of 0.01 mg/cm² to 0.5 mg/cm², and particularly preferably 0.02 mg/cm² to 0.1 mg/cm² per unit area of CCM. When the supported amount is less than 0.01 mg/cm², the durability may be insufficient, and when the supported amount is more than 0.5 mg/cm², the catalyst cost may increase despite the performance.

The cathode catalyst layer and the anode catalyst layer in the present embodiment contain a proton conductive ionomer in addition to the oxygen reduction catalyst, the fuel oxidation catalyst, and the water electrolysis catalyst. The reverse potential durability water electrolysis catalyst for cation exchange membrane fuel cell using the iridium-containing oxide in the present embodiment can maintain reverse potential durability having a longer life with a smaller used amount of iridium than that of the conventional reverse potential durability catalyst.

### EXAMPLES

Hereinafter, the present invention will be described in more detail with reference to Examples, but the present invention is not construed as being limited to Examples. In Examples, “part” and “%” represent “part by mass” and “% by mass”, respectively, unless otherwise specified. The number of parts added is a value in terms of solid content.

### <Example 1>Preparation of Iridium Oxide IrO₂ (IO-1)

To 7 L of water, 100.86 g of an iridium nitrate solution (Furuya metal Co., Ltd.) (iridium content rate: 6.94% by weight) was added, and an iridium compound solution homogeneously dissolved was prepared by stirring and ultrasonic treatment to obtain a metal compound solution as a raw material. Next, oxygen was bubbled into water at room temperature (25° C.) to obtain a saturated dissolved oxygen concentration, and then the water temperature was adjusted to 420° C. and the water pressure was adjusted to 30 MPa to obtain high temperature and high pressure water. Next, the metal compound solution obtained in the above was allowed to flow to a reaction unit (4) at a rate of 30 mL/min, and the high temperature and high pressure water obtained in the above was allowed to flow to the reaction unit (4) at a rate of 200 mL/min, whereby mixing was performed in the reaction unit (4) to obtain an iridium oxide dispersion liquid. Thereafter, the iridium oxide dispersion liquid after mixing in a cooling unit (8) was cooled to normal temperature and normal pressure (20° C. and 1 atm) and recovered in a recovery unit (7). Thereafter, the iridium oxide dispersion liquid was filtered through a membrane filter, and the filter cake was then dried in an electric dryer at 80° C. for 4 hours to obtain 8.62 g of an iridium oxide IrO₂.

Regarding the obtained iridium oxide, a nitrogen adsorption/desorption isotherm was measured using a measurement program “adsorption/desorption isotherm” (manufactured by BEL Japan, INC.) of an automatic specific surface area/pore distribution measuring device BELSORP-minill. The adsorption/desorption isotherm is shown in FIG. 2. As shown in FIG. 2, it has been found that an adsorption/desorption isotherm, in which a relative pressure (P/P₀) sharply rises from about 0.7, is obtained, and a deviation is present between the adsorption isotherm and the desorption isotherm while the relative pressure (P/P₀) is 0.7 to 0.9, to exhibit so-called hysteresis.

The data of the adsorption/desorption isotherm was analyzed by a “BJH method” to find a total pore volume and an average pore diameter, and was analyzed by a “BET method” to find a specific surface area. The results are shown in Table 1. In Example 1, an iridium oxide was obtained, which had a relatively large total pore volume of 0.232 cm³/g, average pore diameter of 7.88 nm, and specific surface area of 118 m²/g.

TABLE 1

| | TOTAL PORE | AVERAGE PORE | SPECIFIC |
|---|---|---|---|
| | VOLUME | DIAMETER | SURFACE AREA |
| | [cm³/g] | [nm] | [m²/g] |
| EXAMPLE 1 | 0.232 | 7.88 | 118 |
| EXAMPLE 2 | 0.397 | 12.5 | 127 |
| EXAMPLE 3 | 0.349 | 11.2 | 125 |
| EXAMPLE 7 | 0.407 | 11.5 | 141 |
| COMPARATIVE EXAMPLE 1 | 0.083 | 5.03 | 65.9 |
| COMPARATIVE EXAMPLE 2 | 0.140 | 2.58 | 217 |

### <Example 2>Preparation of Iridium Oxide IrO₂ (IO-2)

To 2 L of water, 28.98 g of an iridium nitrate solution (Furuya metal Co., Ltd.) (iridium content rate: 6.94% by weight) was added, and an iridium compound solution homogeneously dissolved was prepared by stirring and ultrasonic treatment to obtain a metal compound solution as a raw material. Next, 30% hydrogen peroxide aqueous solution was added to water so that the regulated concentration was 1 g/L. Then, the water temperature was adjusted to 420° C. and the water pressure was adjusted to 30 MPa to obtain high temperature and high pressure water. Next, the metal compound solution obtained in the above was allowed to flow to a reaction unit (4) at a rate of 30 mL/min, and the high temperature and high pressure water obtained in the above was allowed to flow to the reaction unit (4) at a rate of 200 mL/min, whereby mixing was performed in the reaction unit (4) to obtain an iridium oxide dispersion liquid. Thereafter, the iridium oxide dispersion liquid after mixing in a cooling unit (8) was cooled to normal temperature and normal pressure (20° C. and 1 atm) and recovered in a recovery unit (7). Thereafter, the iridium oxide dispersion liquid was filtered through a membrane filter, and the filter cake was then dried in an electric dryer at 80° C. for 4 hours to obtain 2.10 g of an iridium oxide IrO₂.

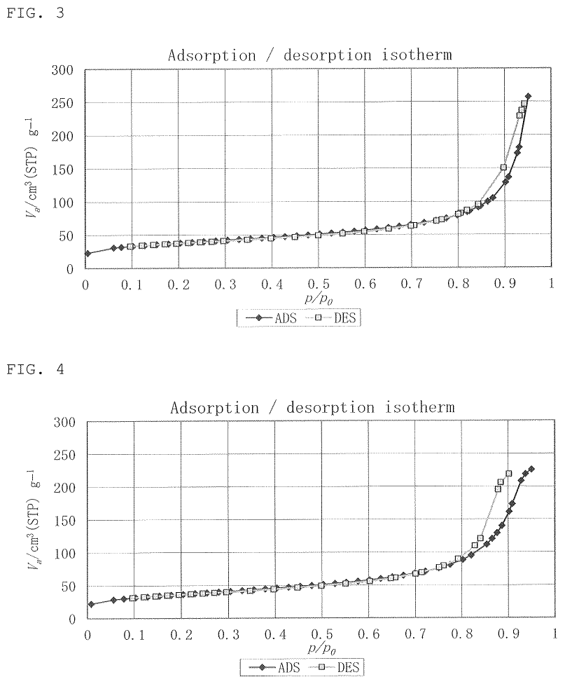

Regarding the obtained iridium oxide, a nitrogen adsorption/desorption isotherm was measured using a measurement program “adsorption/desorption isotherm” (manufactured by BEL Japan, INC.) of an automatic specific surface area/pore distribution measuring device BELSORP-minill. The adsorption/desorption isotherm is shown in FIG. 3. As shown in FIG. 3, it has been found that an adsorption/desorption isotherm, in which a relative pressure (P/P₀) sharply rises from about 0.8, has a steep curve and a deviation is present between the adsorption isotherm and the desorption isotherm from the relative pressure (P/P₀) of 0.8, to exhibit so-called hysteresis.

The data of the adsorption/desorption isotherm was analyzed by a “BJH method” to find a total pore volume and an average pore diameter, and was analyzed by a “BET method” to find a specific surface area. The results are shown in Table 1. In Example 2, an iridium oxide was obtained, which had a relatively large total pore volume of 0.397 cm³/g, average pore diameter of 12.5 nm, and specific surface area of 127 m²/g.

<Example 3>Preparation of Iridium Oxide IrO₂ (10-3)

To 2 L of water, 23.44 g of an iridium nitrate solution (Furuya metal Co., Ltd.) (iridium content rate: 8.66% by weight) was added, and an iridium compound solution homogeneously dissolved was prepared by stirring and ultrasonic treatment to obtain a metal compound solution as a raw material. Next, synthesis was performed in the same manner as in Example 2 except that 30% hydrogen peroxide aqueous solution was added to water so that the regulated concentration was 2 g/L.

Regarding the obtained iridium oxide, a nitrogen adsorption/desorption isotherm was measured using a measurement program “adsorption/desorption isotherm” (manufactured by BEL Japan, INC.) of an automatic specific surface area/pore distribution measuring device BELSORP-minill. The adsorption/desorption isotherm is shown in FIG. 4. As shown in FIG. 4, it has been found that an adsorption/desorption isotherm, in which a relative pressure (P/P₀) sharply rises from about 0.8, has a steep curve and a deviation is present between the adsorption isotherm and the desorption isotherm from the relative pressure (P/P₀) of 0.8, to exhibit so-called hysteresis.

The data of the adsorption/desorption isotherm was analyzed by a “BJH method” to find a total pore volume and an average pore diameter, and was analyzed by a “BET method” to find a specific surface area. The results are shown in Table 1. In Example 3, an iridium oxide was obtained, which had a relatively large total pore volume of 0.349 cm³/g, average pore diameter of 11.2 nm, and specific surface area of 125 m²/g.

### <Example 7>Preparation of Iridium Oxide IrO₂ (10-6)

1.0 L (iridium content: 0.629 g/L) of an iridium hydroxide slurry solution (manufactured by Fluya Metal Co., Ltd.) was prepared, and NaOH was added to the solution to adjust the pH to 12.5, thereby obtaining a metal compound dispersion liquid as a raw material. Next, synthesis was performed in the same manner as in Example 3 except that 30% hydrogen peroxide aqueous solution was added to water so that the regulated concentration was 2 g/L.

Regarding the obtained iridium oxide, a nitrogen adsorption/desorption isotherm was measured using a measurement program “adsorption/desorption isotherm” (manufactured by BEL Japan, INC.) of an automatic specific surface area/pore distribution measuring device BELSORP-minill. The adsorption/desorption isotherm is shown in FIG. 10. As shown in FIG. 10, it has been found that an adsorption/desorption isotherm, in which a relative pressure (P/P₀) sharply rises from about 0.8, has a steep curve and a deviation is present between the adsorption isotherm and the desorption isotherm from the relative pressure (P/P₀) of 0.8, to exhibit so-called hysteresis.

The data of the adsorption/desorption isotherm was analyzed by a “BJH method” to find a total pore volume and an average pore diameter, and was analyzed by a “BET method” to find a specific surface area. The results are shown in Table 1. In Example 7, an iridium oxide was obtained, which had a relatively large total pore volume of 0.407 cm³/g, average pore diameter of 11.5 nm, and specific surface area of 141 m²/g.

### <Comparative Example 1>Preparation of Iridium Oxide IrO₂ (10-4)

In a 5 LTeflon (registered trademark) beaker, 50 g of an iridium chloride tetravalent adjusted product (H₂lrCl₆nH₂O manufactured by Furuya Metal Co., Ltd.) in terms of Ir weight was put. 1.6 L of pure water was added to the adjusted product, followed by stirring for 1 hour while raising the liquid temperature to 80° C. to prepare an iridium chloride solution. Next, a 10% NaOH solution was prepared, in which NaOH of a molar equivalent of 7.8 times was dissolved in pure water in an amount of 9 times, and the 10% NaOH solution was added dropwise to the iridium chloride solution at a rate of 12.5 mL/min. After the completion of the dropwise addition, the mixture was further stirred for 10 hours while the liquid temperature was maintained at 80° C. The generated slurry was allowed to cool to room temperature and then allowed to stand, and the supernatant liquid was decanted. 1300 mL of pure water was added into the Teflon (registered trademark) beaker containing the remaining slurry, and the mixture was stirred for 1 hour while the temperature was raised again to 80° C., allowed to cool to room temperature, and then allowed to stand, and the supernatant liquid was decanted again. Such decantation washing was performed until the conductivity of the supernatant liquid reached 2 mS/m or less. Thereafter, the supernatant liquid was filtered through a membrane filter. The filter cake was then dried in an electric dryer at 60° C. for 20 hours, and then fired in the air at 400° C. for 10 hours using an electric furnace to obtain 58 g of an iridium oxide IrO₂.

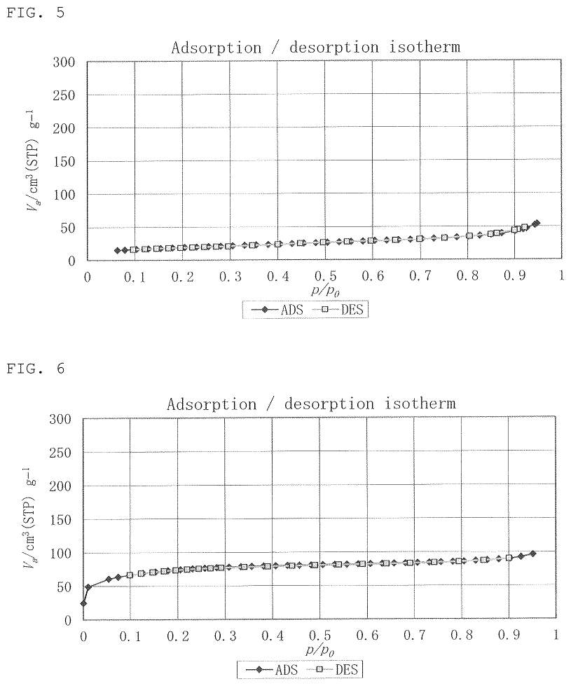

Regarding the obtained iridium oxide, a nitrogen adsorption/desorption isotherm was measured using a measurement program “adsorption/desorption isotherm” (manufactured by BEL Japan, INC.) of an automatic specific surface area/pore distribution measuring device BELSORP-minill. The adsorption/desorption isotherm is shown in FIG. 5. As shown in FIG. 5, it has been found that an adsorption/desorption isotherm at a relative pressure (P/P₀) of about 0.1 to 0.8 has a curve with a gentle slope, and the adsorption isotherm and the desorption isotherm are hardly deviated from each other at the relative pressure (P/P₀) of about 0.1 to 0.8, to exhibit almost no so-called hysteresis.

The data of the adsorption/desorption isotherm was analyzed by a “BJH method” to find a total pore volume and an average pore diameter, and was analyzed by a “BET method” to find a specific surface area. The results are shown in Table 1. In Comparative Example 1, an iridium oxide was obtained, which had a significantly smaller total pore volume of 0.083 cm³/g, average pore diameter of 5.03 nm, and specific surface area of 65.9 m²/g than those of the iridium oxides of Examples 1 to 3 and Example 7.

### <Comparative Example 2>Preparation of Iridium Oxide IrO₂ (10-5)

In a 1 L three-necked glass flask, 3.45 g of an iridium chloride tetravalent adjusted product (H₂lrCl₆·nH₂O manufactured by Furuya Metal Co., Ltd.) in terms of Ir weight was put. 620 mL of 2-propanol was added to the adjusted product, followed by stirring and dissolving at room temperature of 25° C. for 1.5 hours. Sodium nitrate having an Ir salt weight ratio of 50 times was added to this solution in a powder state where it was pulverized in a mortar in advance, followed by stirring at room temperature for 1 hour. The slurry was concentrated to dryness under reduced pressure using a rotary evaporator at a water bath temperature of 50° C. and a degree of vacuum of 50 hPa for 3 hours. The obtained solid was pulverized in a mortar, placed in an alumina tray, charged in the air in a muffle furnace, and melted by heating at 400° C. for 5 hours. After the melted product was allowed to cool to room temperature, 1 L of pure water was added to the melt-solidified product for dissolution and extraction. The obtained slurry was filtered through a membrane filter, washed with warm water to a filtrate conductivity of 1 mS/m or less, and then dried in an electric dryer under conditions of 60° C. and 16 hours to obtain 4.0 g of an iridium oxide IrO₂.

Regarding the obtained iridium oxide, a nitrogen adsorption/desorption isotherm was measured using a measurement program “adsorption/desorption isotherm” (manufactured by BEL Japan, INC.) of an automatic specific surface area/pore distribution measuring device BELSORP-minill. The adsorption/desorption isotherm is shown in FIG. 6. As shown in FIG. 6, an adsorption/desorption isotherm at a relative pressure (P/P₀) of about 0.01 to 0.2 had a steeply rising curve, but the adsorption/desorption isotherm at a relative pressure (P/P₀) of about 0.2 to 0.8 had a curve with a gentle slope. Moreover, almost no deviation was observed between the adsorption isotherm and the desorption isotherm at the relative pressure (P/P₀) of about 0.2 to 0.8. The adsorption/desorption isotherm had a typical micropore structure with almost no so-called hysteresis.

The data of the adsorption/desorption isotherm was analyzed by a “BJH method” to find a total pore volume and an average pore diameter, and was analyzed by a “BET method” to find a specific surface area. The results are shown in Table 1. In Comparative Example 2, an iridium oxide was obtained, which had a significantly smaller total pore volume of 0.140 cm³/g and average pore diameter of 2.58 nm, and a significantly larger specific surface area of 217 m²/g than those of the iridium oxides of Examples 1 to 3 and Example 7.

### <Example 4>Evaluation of Mass Activity of Oxygen Evolution Reaction (OER) as Water Electrolysis Catalyst

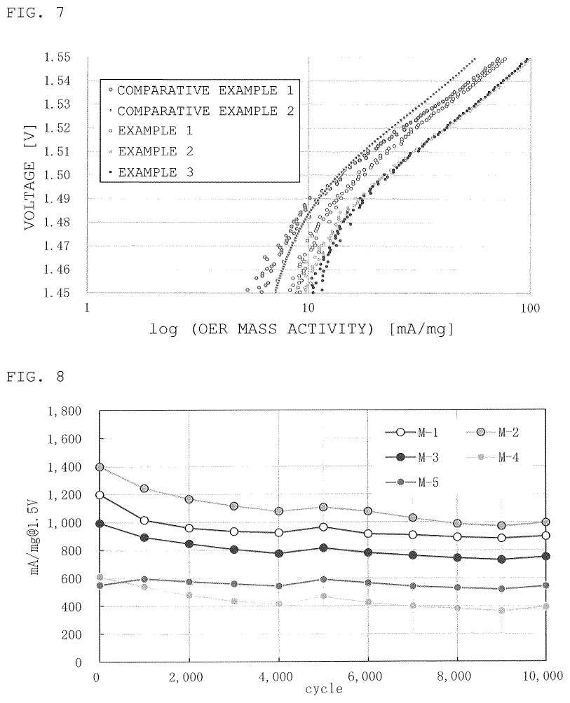

Regarding each of the iridium oxides (IO-1) to (10-6) of Examples and Comparative Examples, a dispersion liquid, obtained by dispersing 14.7 mg of each iridium oxide in a mixed solution of 15 mL of ultrapure water, 10 mL of 2-propanol (hereinafter, IPA), and 0.1 mL of a 5% by mass Nafion dispersion liquid (manufactured by Dupont) with ultrasonic waves, was added onto a rotating disk gold electrode using a micropipette to prepare a catalyst coated electrode of 30 μg/cm². The electrode thus prepared was subjected to a square wave durability test using an electrochemical measurement system device (HZ-7000, manufactured by HOKUTO DENKO CORPORATION). As an electrolytic solution, a solution was used, which was prepared by preparing, from a 60% by mass perchloric acid solution (reagent for precision analysis, manufactured by KANTO KAGAKU), 0.1 M thereof, followed by degassing with Ar gas. A three⁻electrode method was employed as a measurement method, and a hydrogen reference electrode, in which hydrogen gas was allowed to pass through platinum black, was used as a reference electrode. The measurement was performed in a thermostatic bath at 25° C. The mass activity of the oxygen evolution reaction (hereinafter, also referred to as OER) was evaluated by sweeping a voltage range of 1.0 V to 1.8 V at a rate of 10 mV/sec, and dividing a current density (mA/cm²) at 1.5 V by the amount of a catalyst applied to the electrode (30 μg/cm²). The results are shown in FIG. 7 and Table 2. The sample prepared in Example 1 had OER mass activity of 1.28 times higher than that of the sample of Comparative Example 1. The sample prepared in Example 2 had OER mass activity of 1.60 times higher than that of the sample of Comparative Example 1. The sample prepared in Example 3 had OER mass activity of 1.57 times higher than that of the sample of Comparative Example 1. The sample prepared in Example 7 had OER mass activity of 1.08 times higher than that of the sample of Comparative Example 1. It was demonstrated that all Examples had high activity as a water electrolysis anode catalyst. Meanwhile, the OER mass activity of the sample prepared in Comparative Example 2 was low and 1.02 times as high as, i.e., almost the same as, that of the sample of Comparative Example 1. The low OER mass activity of the catalyst of Comparative Example 2 despite its high specific surface area suggests that the contribution of micropores to water electrolysis catalyst activity is significantly low.

TABLE 2

| | | ACTIVITY MAGNIFICATION |
|---|---|---|
| | | RATIO |
| | | (OER MASS ACTIVITY OF EACH |
| | | OF CATALYSTS OF EXAMPLES |
| | | AND COMPARATIVE EXAMPLES/ |
| | OER MASS | OER MASS ACTIVITY OF |
| | ACTIVITY AT | CATALYST OF COMPARATIVE |
| | 1.5 V | EXAMPLE 1) |
| | [mA/mg] | [MAGNIFICATION] |
| EXAMPLE 1 | 17.9 | 1.28 |
| EXAMPLE 2 | 22.4 | 1.60 |
| EXAMPLE 3 | 22.0 | 1.57 |
| EXAMPLE 7 | 15.1 | 1.08 |
| COMPARATIVE EXAMPLE 1 | 14.0 | — |
| COMPARATIVE EXAMPLE 2 | 14.3 | 1.02 |

### <Example 5>Evaluation of Single Cell of Solid Polymer Membrane Water Electrolysis Electrode Catalyst

### [5-1) Production of Anode Catalyst Sheet for Water Electrolysis Cell]

Each of the iridium oxides (IO-1) to (10-5) of Examples and Comparative Examples was weighed, and ultrapure water, 2-propanol, and a 5% by mass Nafion dispersion liquid (manufactured by DuPont) were added to each of the iridium oxides, followed by stirring with a magnetic stirrer. Then, each of the iridium oxides was dispersed using a strong ultrasonic disperser. Finally, the dispersed product was stirred and mixed again using a magnetic stirrer to obtain an anode catalyst paste. A Teflon (registered trademark) sheet having a thickness of 50 μm was brought into close contact with the glass surface of a wire bar coater with a doctor blade (PM-9050MC, manufactured by SMT Co., Ltd). The anode catalyst paste was added onto the surface of the Teflon (registered trademark) sheet, and the blade was swept to apply the anode catalyst paste. The wet sheet was air-dried in the air for 15 hours, and then dried in a vacuum dryer at 120° C. for 1.5 hours to obtain an anode catalyst sheet. The amount of the catalyst applied per the unit area of the catalyst sheet was adjusted to 1.0 mg/cm². The dried anode catalyst sheet was cut into a circle having an electrode effective area of 9 cm², necessary for evaluation with a Thomson blade, to obtain an anode catalyst sheet AS-1 using the catalyst of Example 1, an anode catalyst sheet AS-2 using the catalyst of Example 2, an anode catalyst sheet AS-3 using the catalyst of Example 3, an anode catalyst sheet AS-4 using the catalyst of Comparative Example 1, and an anode catalyst sheet AS-5 using the catalyst of Comparative Example 2 for the evaluation of the durability of a cation exchange membrane water electrolysis single cell.

[5-2) Production of Cathode Catalyst Sheet for Water Electrolysis Cell]

Ketjen Black EC300J (manufactured by AKZO NOBEL) was ultrasonically dispersed in deionized water, and a slurry, obtained by ultrasonically dispersing platinum black having a high specific surface area (FHPB, BET specific surface area: 85 m²/g, manufactured by Furuya Metal Co., Ltd.) in deionized water, was added thereto to prepare 50% by mass Pt-supported carbon, which was used as a cathode catalyst. A 50% by mass Pt-supported carbon powder was weighed, and ultrapure water, 2-ethoxyethanol, 2-propanol, and a 5% by mass Nafion dispersion liquid (manufactured by Dupont) were added thereto, followed by stirring and mixing using a magnetic stirrer and an intense ultrasonic disperser, to obtain a cathode catalyst paste. A Teflon (registered trademark) sheet having a thickness of 50 μm was brought into close contact with the glass surface of a wire bar coater with a doctor blade. The cathode catalyst paste was added onto the surface of the Teflon (registered trademark) sheet, and the blade was swept to apply the anode catalyst paste. This was air-dried in the air for 15 hours, and then dried in a vacuum dryer at 120° C. for 1.5 hours to obtain a cathode catalyst sheet. The amount of the catalyst applied per the unit area of the catalyst sheet was adjusted to 1.0 mg/cm². The dried cathode catalyst sheet was cut into a circle of 9 cm² for an electrode effective area with a Thomson blade to obtain a cathode catalyst sheet CS-1 for the evaluation of the durability of a cation exchange membrane water electrolysis single cell.

[5-3) Production of Catalyst Coated Memblen (CCM) for Water Electrolysis Cell]

A cation exchange membrane Nafion 115 (manufactured by Dupont) was cut into cb 70 mm. This was sandwiched between the anode catalyst sheet AS-1, AS-2, AS-3, AS-4 or AS-5 cut into the electrode active area and the cathode catalyst sheet CS-1 with the catalyst-applied surfaces facing inward and the centers thereof aligned. These were pressed with a high precision hot press (manufactured by Tester Sangyo Co., Ltd.) at 145° C. and 0.5 kN/cm² for 3 minutes. After pressing, the Teflon (registered trademark) sheet attached to each of the anode and the cathode was peeled off to obtain CCM M-1 (AS-1/CS-1), M-2 (AS-2/CS-1), and M-3 (AS-3/CS-1) of catalysts of Examples and CCM M-4 (AS-4/CS-1) and M-5 (AS-5/CS-1) of catalysts of Comparative Examples.

[5-4) Evaluation of Accelerated Degradation Durability of Solid Polymer Membrane Water Electrolysis Single Cell]

A water electrolysis cell unit (manufactured by FC Development Co, Ltd.) having an electrode effective area of 9 cm² was prepared. A Pt-plated Ti sintered body for an anode and carbon paper for a cathode were used as gas diffusion layers. These gas diffusion layers and each of the CCMs M-1, M-2, and M-3 of the catalysts of Examples or the CCMs M-4 and M-5 of the catalysts of Comparative Examples prepared above were incorporated into a single cell, and tightened with a tightening bolt. The anode side and the cathode side of this unit cell were respectively connected to a pure water supply line and a gas supply line of a water electrolysis/fuel cell evaluation apparatus (AUTO-PE, manufactured by TOYO Corporation). In the evaluation of the accelerated deterioration durability of the cation exchange membrane water electrolysis single cell, the cell temperature was set to 80° C., and warm pure water having a conductivity of 0.1 mS/m or less was supplied to the anode at a flow rate of 30 mL/min. Initial I-V characteristics were measured. Thereafter, 1 V to 2 V and 2 V to 1 V were set as 1 cycle at a sweep rate of 0.5 V/sec, and a total of 10,000 cycles were performed. Finally, I-V characteristics were measured again. FIG. 8 shows the comparison of the accelerated degradation tests of water electrolysis single cells using the catalysts of Examples and Comparative Examples as an anode, showing the transition of the mass activity of each of the catalysts CCM M-1, M-2, and M-3 of Examples and the catalysts CCM M-4 and M-5 of Comparative Examples per 1,000 cycles in the durability test up to 10,000 cycles. Tafel-Plot was performed from the results of I-V characteristics, and an activity maintenance rate was calculated from the ratio of mass activities before and after the cycle test at an electrolytic voltage of 1.5 V free of internal resistance (IR). Table 3 shows the comparison of the OER mass activity and the maintenance rate before and after the cycle test of the water electrolysis single cell using each of the catalysts of Examples and Comparative Examples as an anode. The CCM M-1, M-2, and M-3 of the catalysts of Examples respectively had 1.97 times, 2.29 times, and 1.63 times higher initial activities at 1.5 V than that of the CCM M-4 of the catalyst of Comparative Example, and respectively had activity maintenance rates of 74.7%, 71.0%, and 75.3% higher than 63.9% of that of the CCM M-4 of the catalyst of Comparative Example. It was demonstrated that the catalysts of Examples have high performance as a water electrolysis anode catalyst in terms of both activity and durability.

Meanwhile, the initial activity of the CCM M-5 of the catalyst of Comparative Example 2 was 0.902 times lower than that of the CCM M-4 of the catalyst of Comparative Example 1. Even though the activity maintenance rate was as high as 98.1%, the OER mass activity after endurance was far inferior to the OER mass activities of the catalysts of Examples.

TABLE 3

| | | | | INITIAL ACTIVITY |
|---|---|---|---|---|
| | | | | MAGNIFICATION RATIO |
| | | OER MASS | | (INITIAL OER MASS ACTIVITY |
| | | ACTIVITY | | OF EACH OF EXAMPLES AND |
| | INITIAL | AFTER | ACTIVITY | COMPARATIVE EXAMPLES/ |
| | OER MASS | 10,000 | MAINTENANCE | INITIAL OER MASS |
| | ACTIVITY | CYCLES | RATE | ACTIVITY OF M-4) |
| | [mA/mg] | [mA/mg] | [%] | [MAGNIFICATION] |
| M-1 | 1198.5 | 895.5 | 74.7 | 1.97 |
| (EXAMPLE) | | | | |
| M-2 | 1397.0 | 992.5 | 71.0 | 2.29 |
| (EXAMPLE) | | | | |
| M-3 | 992.0 | 747.0 | 75.3 | 1.63 |
| (EXAMPLE) | | | | |
| M-4 | 609.5 | 389.5 | 63.9 | — |
| (COMPARATIVE | | | | |
| EXAMPLE) | | | | |
| M-5 | 549.5 | 539.0 | 98.1 | 0.902 |
| (COMPARATIVE | | | | |
| EXAMPLE) | | | | |

### <Example 6>Evalutation of Reverse Potential Durability of Cation Exchange Membrane Fuel Cell of Water Electrolysis Catalyst

### [6-1) Production of Electrode Catalyst Sheet for Fuel Cell]

A cathode catalyst sheet CS-2 for evaluation of fuel cell reverse potential durability was obtained in the same manner as in 5-2) of Example 5 except that 50% by mass Pt-supported carbon was prepared using highly graphitized carbon black FCX-80 (manufactured by CABOT) instead of Ketjen Black EC300J in 5-2) of Example 5. The amount of the catalyst applied per unit area was adjusted to 1.0 mg/cm². An anode catalyst sheet AS-6 for evaluation of fuel cell reverse potential durability was obtained in the same manner as in 5-2) of Example 5 except that a catalyst paste was prepared by mixing 50% by mass Pt-supported carbon using FCX-80 and the catalyst 10-1 of Example 1 at a weight ratio of 95:5, and used. The amount of the catalyst applied per unit area was adjusted to 1.0 mg/cm². Furthermore, an anode catalyst sheet AS-7 for evaluation of fuel cell reverse potential durability was obtained in the same manner as in the above except that the catalyst 10-4 of Comparative Example 1 was used instead of the catalyst 10-1 of Example 1 in the preparation of the AS-6.

[6-2) Production of CCM for Fuel Cell]

A cation exchange membrane Nafion NRE-212 (manufactured by Dupont) was cut into 100 mm×100 mm. The cathode catalyst sheet (CS-2) produced in 6-1) of Example 6 and the anode catalyst sheet (AS-6) containing the catalyst 10-1 of Example 1 produced in 6-1) of Example 6 were sandwiched with the catalyst-applied surfaces facing inward and the centers thereof aligned. These were pressed with a hot press (high precision hot press for MEA production, manufactured by Tester Sangyo Co., Ltd.) at 140° C. and 2 kN/cm² for 3 minutes. After taking out, Teflon (registered trademark) sheets on the front and back surfaces were peeled off, to obtain CCM M-6 (AS-6/CS-2) of Example 6.

CCM M-7 (AS-7/CS-2) of Comparative Example was obtained by performing the same manner as described above except that an anode catalyst sheet (AS-7) was used instead of the anode catalyst sheet (AS-6).

### [6-3) Evaluation of Fuel Cell Reverse Potential Durability]

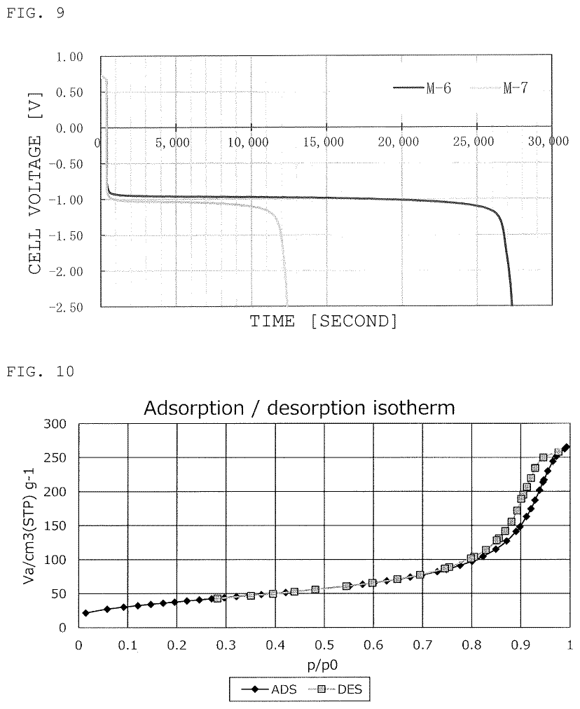

A PEFC single cell (manufactured by FC Development Co, Ltd.) produced according to the standard cell specification of JARI (Japan Automobile Research Institute) except that the electrode effective area was set to 30 mm×30 mm was prepared. The CCM M-6 containing the catalyst of Example 1 as a water electrolysis catalyst was incorporated into a single cell, and a fastening bolt was fastened at a torque of 4 Nm. This single cell was connected to a gas supply line of a fuel cell evaluation apparatus (AUTO-PE, manufactured by TOYO Corporation). The reverse potential durability test was performed as follows according to the method of Non Patent Literature 3. The cell temperature was set to 40° C., hydrogen was humidified to an anode and air (Zero Air gas) was humidified to a cathode by a humidifier so as to have a dew point of 40° C. each, and then hydrogen was supplied to the anode at a flow rate of 200 mL/min and air was supplied to the cathode at a flow rate of 600 mL/min. The fuel cell single cell was operated for 1 hour, and the initial I-V characteristics were measured. Thereafter, the anode gas was completely replaced with nitrogen gas, and a current density of 0.2 A/cm² was forcibly supplied from an external power source to simulate a reverse potential state. The temporal change of the cell voltage was monitored, and the time required for the cell voltage to exceed minus 2.0 V from the start of energization at a current density of 0.2 A/cm² was 27,123 seconds, which was defined as a reverse potential endurance time. CCM M-7 containing the catalyst of Comparative Example 1 as a water electrolysis catalyst was evaluated in the same manner as in Example 6. The time required for the cell voltage to exceed minus 2.0 V from the start of energization at a current density of 0.2 A/cm² was 12,216 seconds. FIG. 9 shows the results of the reverse potential durability evaluation test. From FIG. 9, CCM for fuel cell in which the catalyst of Example was added as a water electrolysis catalyst was found to exhibit remarkably higher reverse potential durability than that of the catalyst of Comparative Example.

### REFERENCE SIGNS LIST

(1) first source
(2) second source
(3) heating unit
(4) reaction unit
(5) liquid feeding route
(6) liquid feeding route
(7) recovery unit
(8) cooling unit
(9) mechanism for transferring liquid in one direction
(10) mechanism for transferring liquid in one direction
(11) pressure adjustment mechanism

What is claimed is:

1. An iridium-containing oxide having a total pore volume of 0.20 cm³/g or more, calculated by a BJH method from nitrogen adsorption/desorption isotherm measurement, and a pore distribution having an average pore diameter of 7.0 nm or more.

2. The iridium-containing oxide according to claim 1, wherein the iridium-containing oxide has hysteresis in a region where a relative pressure (P/P₀) of a nitrogen adsorption/desorption isotherm is 0.7 to 0.95.

3. The iridium-containing oxide according to claim 1, wherein the iridium-containing oxide has a BET specific surface area of 100 m²/g or more.

4. The iridium-containing oxide according to claim 1, wherein the iridium-containing oxide is an iridium oxide or a composite oxide of iridium and an element whose oxide has a rutile type crystal structure, and the iridium oxide or the composite oxide has a rutile type crystal structure.

5. A method for producing the iridium-containing oxide according to claim 1,
the method comprising:
a step A of (1) dispersing iridium nanoparticles or iridium hydroxide particles as a raw material in a medium to obtain a dispersion liquid or (2) dissolving an iridium compound as a raw material in a solvent to obtain a solution;
a step B of converting water into high-temperature and high-pressure water under high-temperature and high-pressure conditions of a heating temperature of 100° C. or higher and an applied pressure of 0.1 MPa or more; and
a step C of mixing the dispersion liquid or the solution obtained in the step A with the high-temperature and high-pressure water obtained in the step B.

6. The method for producing the iridium-containing oxide according to claim 5, wherein in the step A, the solvent has a temperature of 15 to 30° C., and the iridium compound as the raw material is dissolved in the solvent.

7. The method for producing the iridium-containing oxide according to claim 5, wherein the step B comprises any one of the steps of: (1) adding an oxidant that releases oxygen atoms to the water and then converting the water into the high-temperature and high-pressure water;
(2) converting the water into the high-temperature and high-pressure water and then adding an oxidant that releases oxygen atoms to the high-temperature and high-pressure water, or (3) adding an oxidant that releases oxygen atoms to the water, then converting the water into the high-temperature and high-pressure water, and further adding an oxidant that releases oxygen atoms to the high-temperature and high-pressure water.

8. A cation exchange membrane water electrolysis anode catalyst comprising the iridium-containing oxide according to claim 1.

9. A reverse potential durability catalyst for cation exchange membrane fuel cell, comprising an electrode catalyst layer containing the iridium-containing oxide according to claim 1.

10. The iridium-containing oxide according to claim 2, wherein the iridium-containing oxide has a BET specific surface area of 100 m²/g or more.

11. The iridium-containing oxide according to claim 2, wherein the iridium-containing oxide is an iridium oxide or a composite oxide of iridium and an element whose oxide has a rutile type crystal structure, and the iridium oxide or the composite oxide has a rutile type crystal structure.

12. The iridium-containing oxide according to claim 3, wherein the iridium-containing oxide is an iridium oxide or a composite oxide of iridium and an element whose oxide has a rutile type crystal structure, and the iridium oxide or the composite oxide has a rutile type crystal structure.

13. The iridium-containing oxide according to claim 10, wherein the iridium-containing oxide is an iridium oxide or a composite oxide of iridium and an element whose oxide has a rutile type crystal structure, and the iridium oxide or the composite oxide has a rutile type crystal structure.

14. The method for producing the iridium-containing oxide according to claim 6, wherein the step B comprises any one of the steps of: (1) adding an oxidant that releases oxygen atoms to the water and then converting the water into the high-temperature and high-pressure water; (2) converting the water into the high-temperature and high-pressure water and then adding an oxidant that releases oxygen atoms to the high-temperature and high-pressure water; or (3) adding an oxidant that releases oxygen atoms to the water, then converting the water into the high-temperature and high-pressure water, and further adding an oxidant that releases oxygen atoms to the high-temperature and high-pressure water.
